(19) United States
(12) Patent Application Publication
(10) Pub. No.: US 2010/0053567 A1
(43) Pub. Date: Mar. 4, 2010

(54) PROJECTOR HAVING LED LIGHT SOURCES AND HEAT DISSIPATION DEVICE ASSEMBLY THEREIN

(75) Inventors: Zhi-Sheng Lian, Shenzhen City (CN); Gen-Ping Deng, Shenzhen City (CN); Chun-Chi Chen, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignees: Fu Zhun Precision Industry (Shen Zhen) Co., Ltd., Shenzhen City (CN); Foxconn Technology Co., Ltd., Tu-Cheng (TW)

(21) Appl. No.: 12/202,401

(22) Filed: Sep. 1, 2008

(51) Int. Cl. G03B 21/16

(52) U.S. Cl. 353/61; 353/52

(57) ABSTRACT

A projector includes first, second and third light sources and first, second and third heat dissipation devices attached to and thermally connecting with the light sources for dissipating heat generated thereby. The first heat dissipation device includes a first heat sink located adjacent to a lateral side of the projector from which a lens protrudes, a fin assembly and a bent heat pipe connecting the first heat sink and the fin assembly. The second heat dissipation device includes a base and a plurality of fins located at a rear side of the projector and defining a stepped portion on which the fin assembly of the first heat dissipation device is mounted. The third heat dissipation device includes a base and a plurality of fins and is located adjacent to an opposite lateral side of the projector.

### BACKGROUND OF THE INVENTION

1. Field of the Invention

The present invention relates to a projector, and particularly to a projector having heat dissipation devices for dissipating heat generated by a plurality of LED light sources in the projector.

2. Description of Related Art

Nowadays, projectors are commonly used in many fields such as meetings and presentations in an office or used as a home image output device. Due to a requirement of high brightness, a high power light source is needed in the projector. It becomes a tendency to use a high powered LED as the light source for the projector. After a period of operation, the light source generates a large amount of heat in the projector, which leads to a high temperature that affects the operations of the projector and reduces the lifespan of other elements. To resolve the heat problem in the projector, a heat dissipation device is usually provided. However, due to the limitation of the inner space of the projector, the large amount of heat generated by the light source can not be effectively dissipated by the conventional heat dissipation device.

What is needed, therefore, is a projector having a plurality of light sources with heat dissipation devices respectively attached thereto and thermally connecting therewith, whereby heat generated by the light sources can be effectively dissipated.

### SUMMARY OF THE INVENTION

A projector includes a plurality of light sources and a heat dissipation device assembly attached to and thermally connecting with the light sources for dissipating heat generated by the light sources. The heat dissipation device assembly includes a first heat dissipation device, a second heat dissipation device and a third heat dissipation device, each of the heat dissipation devices being attached to and thermally connecting with a corresponding light source. The first heat dissipation device includes a first heat sink attached to a corresponding light source, a fin assembly and a bent heat pipe connecting the first heat sink and the fin assembly. The second heat dissipation device includes a base attached to a corresponding light source and a plurality of fins. The third heat dissipation device includes a base attached to a corresponding light source and a plurality of fins.

Other advantages and novel features will become more apparent from the following detailed description of preferred embodiments when taken in conjunction with the accompanying drawings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, assembled view of a projector in accordance with a preferred embodiment of the present invention.

FIG. 2 is a view similar to FIG. 1, with a top cover of the projector being removed to show a heat dissipation device assembly therein.

FIG. 3 is an isometric, assembled view of the heat dissipation device assembly of the projector in FIG. 2.

FIG. 4 is a view similar to FIG. 3, but shown from a different aspect.

FIG. 5 is an isometric, assembled view of a first heat dissipation device of the heat dissipation device assembly of FIG. 3.

FIG. 6 is an isometric, assembled view of a second heat dissipation device of the heat dissipation device assembly of FIG. 4.

### DETAILED DESCRIPTION OF THE INVENTION

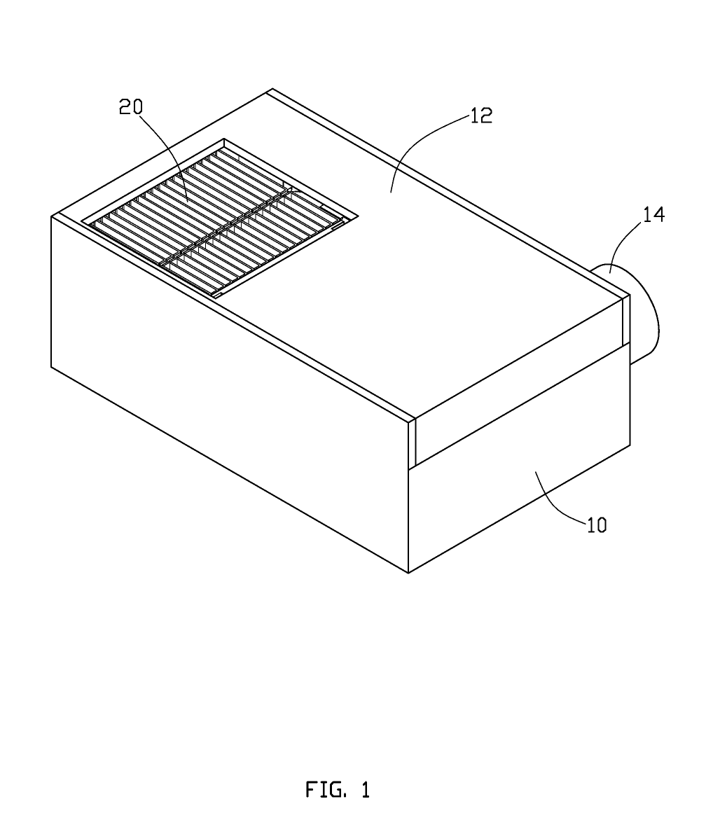

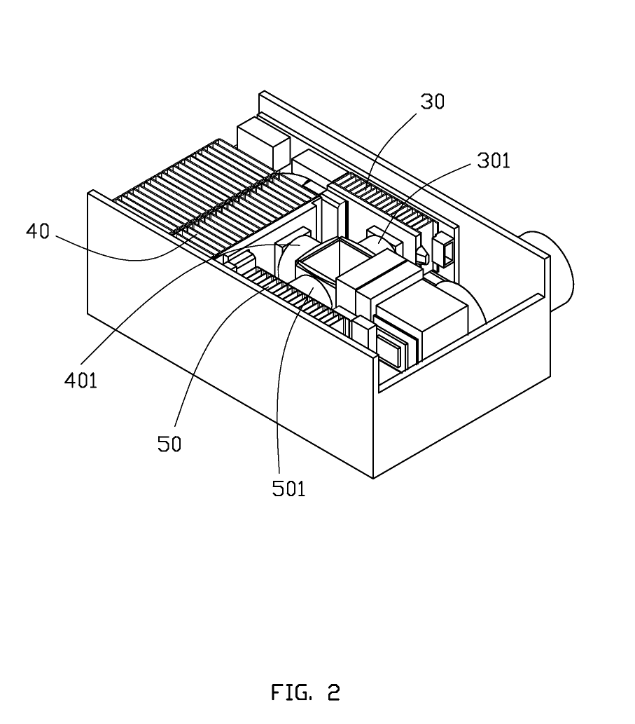

Referring to FIGS. 1-2, a projector in accordance with a present embodiment is illustrated. The projector comprises a main body 10 having a bottom cover (not labeled), a top cover 12 opposite to the bottom cover and covering a top end of the main body 10 to form a housing, and a heat dissipation device assembly 20 received in the housing. A lens 14 protrudes out of a lateral side of the main body 10 for image projection. A hole (not labeled) is defined in the top cover 12 for airflow flowing into the projector to accelerate heat dissipation of the heat dissipation device assembly 20. Corresponding to the hole in the top cover 12, a hole (not shown) is defined in the bottom cover of the main body 10.

The heat dissipation device assembly 20 comprises a first heat dissipation device 30, a second heat dissipation device 40 and a third heat dissipation device 50. A part of the first heat dissipation device 30 is located adjacent to the lateral side of the main body 10. Another part of the first heat dissipation device 30 and the second heat dissipation device 40 are located adjacent to a rear side of the main body 10. The third heat dissipation device 50 is located adjacent to another lateral side of the main body 10. A first, second and third light sources 301, 401, 501 are attached to and thermally connect with the first, second and third heat dissipation devices 30, 40, 50, respectively. In the present embodiment, the first light source 301 has the greatest power among the three, and the third light source 501 has the smallest power among the three. That is to say, the heat generated by the first light source 301 is the most, and the heat generated by the third light source 501 is the least. In accordance with preferred embodiment, the three light sources 301, 401 and 501 are LED lamps respectively of 24.5 W, 12.5 W and 7.35 W.

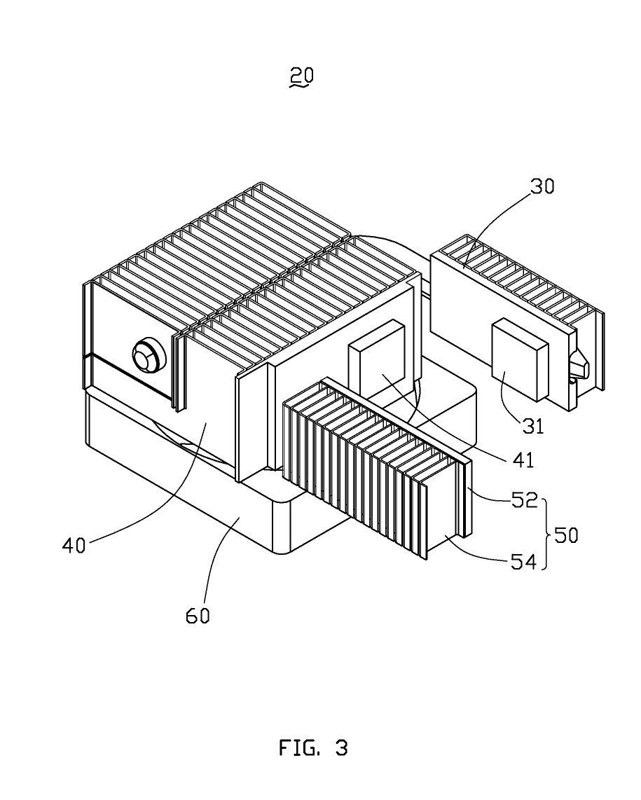

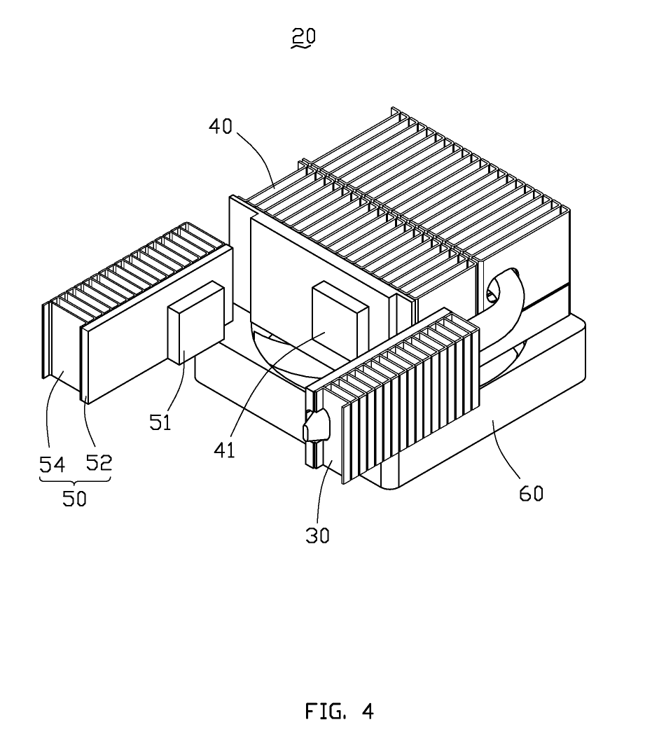

Please also referring to FIGS. 3-4, a cooling fan 60 is located under the second heat dissipation device 40 and corresponding to the position of the hole in the bottom cover of the main body 10 of the projector. The fan 60 provides cooling air to flow through the projector to dissipate heat in the projector.

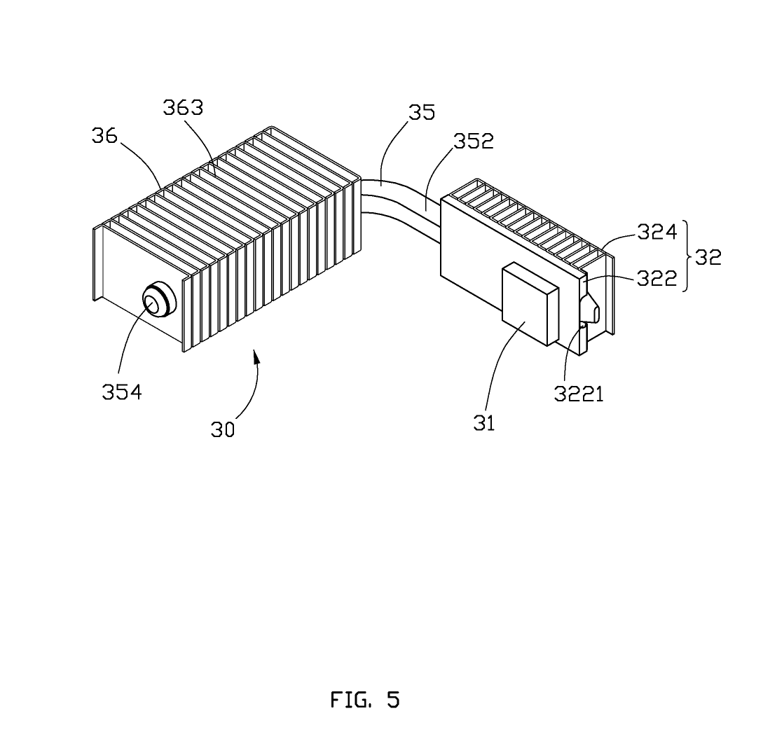

Referring to FIG. 5, the first heat dissipation device 30 comprises a first heat sink 32, a fin assembly 36 and a heat pipe 35 connecting the first heat sink 32 and the fin assembly 36. The first heat sink 32 comprises a rectangular base 322 and a plurality of fins 324 arranged on a lateral side of the base 322. The fins 324 each includes a rectangular-shaped main body (not labeled) and two flanges (not labeled) extending from two lateral side ends of the main body, respectively. The flanges of a rear fin 324 abut against the main body of a front fin 324 so as to form a perpendicular air passage (not labeled) between the two adjacent fins 324, and the fins 324 are combined together by soldering or other means such as by interlocking structures formed between adjacent fins 324. A groove (not labeled) is defined in each of the base 322 and a center of a bottom of the fins 324 of the first heat sink 32. The grooves of the base 322 and the fins 324 cooperatively define a channel 3221 for receiving a part of the heat pipe 35 therein.

The fin assembly 36 of the first heat dissipation device 30 is similar to the fins 324 of the first heat sink 32. A perpendicular air passage 363 is defined between every two adjacent fins of the fin assembly 36. A hole (not labeled) is defined in the fin assembly 36 for receiving another part of the heat pipe 35 therein. The heat pipe 35 is L-shaped and comprises an evaporating portion 352 received in the channel 3221 of the first heat sink 32 and a condensing portion 354 received in the hole of the fin assembly 36. Particularly, the evaporating portion 352 of the heat pipe 35 is flattened and the condensing portion 354 of the heat pipe 35 is round.

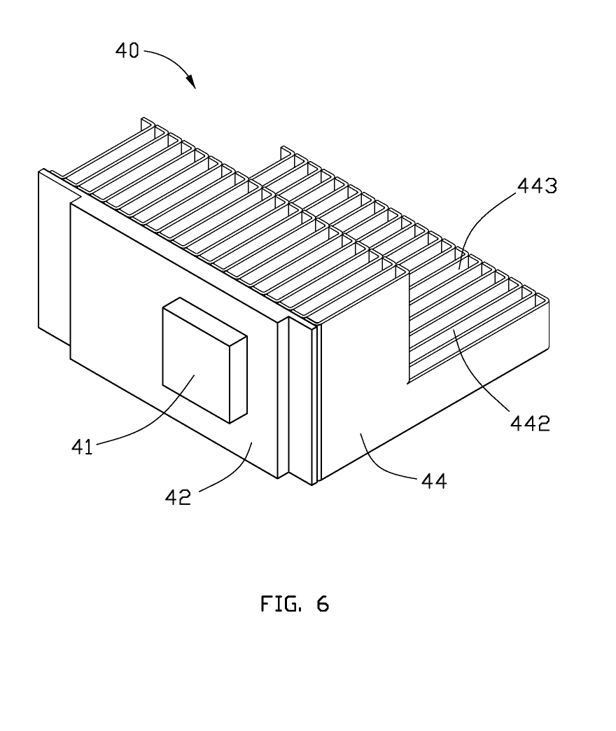

Referring to FIG. 6, the second heat dissipation device 40 comprises a rectangular base 42 and a plurality of fins 44 arranged on a rear side of the base 42. A height of a portion of the fins 44 adjacent to the base 42 is larger than that of another portion of fins 44 far away from the base 42, to thereby form a step 442 on a top surface of the fins 44 for receiving the fin assembly 36 of the first heat dissipation device 30. A perpendicular air passage 443 is defined between every two adjacent fins 44. A width of the air passage 443 is identical to that of the air passage 363 of the fin assembly 36 of the first heat dissipation device 30. The fin assembly 36 with the condensing portion 354 of the heat pipe 35 is fittingly mounted on the step 442 of the fins 44 of the second heat dissipation device 40. Therefore, the fins 44 of the second heat dissipation device 40 and the fin assembly 36 of the first heat dissipation device 30 together have a cuboid configuration.

Referring to FIGS. 3-4 again, the third heat dissipation device 50 is separated from the first and second heat dissipation devices 30, 40. The third heat dissipation device 50 comprises a rectangular base 52 and a plurality of fins 54 arranged on a lateral side of the base 52. The structure of the fins 54 is similar to that of the fins 324 of the first heat sink 32 and the fin assembly 36 of the first heat dissipation device 30. The base 52 of the third heat dissipation device 50 and the base 322 of the first heat sink 32 are oriented to face each other. The first, second and third light sources 301, 401, 501 are attached to the bases 322, 42, 52 of the first heat sink 32 and the second and third heat dissipation devices 40, 50, respectively. The first and third light sources 301, 501 are oriented face to face and located at two flanks of the second light source 401.

A heat spreader 31 is sandwiched between the base 322 of the first heat sink 32 and the first light source 301; a heat spreader 41 is sandwiched between the base 42 of the second heat dissipation device 40 and the second light source 401; a heat spreader 51 is sandwiched between the base 52 of the third heat dissipation device 50 and the third light source 501, for reducing a thermal resistance therebetween. In accordance with the embodiment, the heat spreaders 31, 41, 51 are all made of copper. The bases 322, 42 are made of aluminum and the base 52 is made of copper.

Corresponding to the situation that the first light source 301 generating much more heat than the second and third light sources 401, 501, the first heat dissipation device 30 not only uses the first heat sink 32 to dissipate the heat generated by the first light source 301, but also uses the heat pipe 35 to thereby quickly transfer the heat to the fin assembly 36. The heat in the fin assembly 36 is quickly dissipated to a surrounding environment via the cooling fan 60.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A projector comprising:
a main body;
a lens protruding from a lateral side of the main body;
a plurality of light sources received in the main body; and
a heat dissipation device assembly received in the main body comprising a first heat dissipation device, a second heat dissipation device and a third heat dissipation device, each of the heat dissipation devices attached to and thermally connecting with a corresponding light source;
wherein the first heat dissipation device comprises a first heat sink adjacent to the lateral side of the main body, a fin assembly and a bent heat pipe connecting the first heat sink and the fin assembly, the second heat dissipation device comprises a base and a plurality of fins arranged at a rear side of the base, and the third heat dissipation device comprises a base and a plurality of fins and is located adjacent to an opposite lateral side of the main body.

2. The projector as claimed in claim 1, wherein the heat pipe of the first heat dissipation device is L-shaped and comprises an evaporating portion connecting with the first heat sink and a condensing portion connecting with the fin assembly.

3. The projector as claimed in claim 2, wherein the first heat sink of the first heat dissipation device comprises a base and a plurality of fins arranged at a lateral side of the base, a groove is defined in the base and the fins for cooperatively receiving the evaporating portion of the heat pipe therein, and a hole is defined in the fin assembly of the first heat dissipation device for receiving the condensing portion of the heat pipe therein.

4. The projector as claimed in claim 3, wherein the evaporating portion of the heat pipe is flattened and the condensing portion of the heat pipe is round.

5. The projector as claimed in claim 2, wherein a step is formed on a top surface of the fins of the second heat dissipation device for mounting the fin assembly and the condensing portion of the heat pipe of the first heat dissipation device thereon.

6. The projector as claimed in claim 5, wherein the fin assembly of the first heat dissipation device is fittingly mounted on the step whereby the fins assembly of the first heat dissipation device and the fins of the second heat dissipation device cooperatively form a cuboid shape.

7. The projector as claimed in claim 1, wherein the heat dissipation device assembly furthering comprises a fan located under the second heat dissipation device.

8. The projector as claimed in claim 1, wherein the light sources include a first, second and third light sources, and the first, second and third light sources are attached to the first heat sink of the first heat dissipation device, the base of the second heat dissipation device and the base of the third heat dissipation device, respectively.

9. The projector as claimed in claim 8, wherein a heat spreader is sandwiched between each of the light sources and a corresponding one of the first heat sink of the first heat dissipation device and the bases of the second and the third heat dissipation devices, the heat spreader and the base of the third heat dissipation device being made of same metal.

10. The projector as claimed in claim 8, wherein power of the first light source is greater than that of the second light source, and power of the third light source is smaller than that of the second light source.

11. The projector as claimed in claim 1, wherein the third heat dissipation device is separated from the first and second heat dissipation devices.

12. A projector comprising:
a housing;
a first light source, a second light source and a third light source located in the housing;
a fan;
a first heat sink thermally contacting the first light source for absorbing heat from the first light source;
a second heat sink thermally contacting the second light source for absorbing heat from the second light source and mounted over the fan, the second heat sink comprising a base, L-shaped first fins mounted on a first side of the base and second fins mounted on a stepped portion of the first fins, the second light source attached to a second side of the base;
a third heat sink thermally contacting the third light source for absorbing heat from the third light source;
a heat pipe having a first end extending through the first heat sink and a second end extending through the second fins of the second heat sink.

13. The projector as claimed in claim 12, wherein the first and third light sources are oriented face to face and located at two flanks of the second light source.

14. The projector as claimed in claim 13, wherein the first heat sink comprises a base and a plurality of fins extending from the base, the first end of the heat pipe extending in the base and the fins of the first heat sink.

15. The projector as claimed in claim 14, wherein the first end of the heat pipe is flattened, and the second end of the heat pipe is round.

16. The projector as claimed in claim 12, wherein the first, second and third light sources are LED light sources.
